(19) United States
(12) Patent Application Publication
(10) Pub. No.: US 2018/0097234 A1
(43) Pub. Date: Apr. 5, 2018

(54) LITHIUM ION SECONDARY BATTERY

(71) Applicant: TOYOTA JIDOSHA KABUSHIKI KAISHA, TOYOTA-SHI (JP)

(72) Inventor: Masaki ADACHI, Toyota-shi (JP)

(73) Assignee: TOYOTA JIDOSHA KABUSHIKI KAISHA, TOYOTA-SHI (JP)

(21) Appl. No.: 15/714,354

(22) Filed: Sep. 25, 2017

(30) Foreign Application Priority Data
Sep. 30, 2016 (JP) 2016-193238

(51) Int. Cl. H01M 4/62; H01M 10/0525

(52) U.S. Cl. CPC H01M 4/62; Y10S 977/948; H01M 2220/20; H01M 10/0525

(57) ABSTRACT

A lithium ion secondary battery includes a positive electrode, a negative electrode, and an electrolyte solution. At least one of the positive electrode and the negative electrode includes a magnetic field generating material.

### INCORPORATION BY REFERENCE

The disclosure of Japanese Patent Application No. 2016-193238 filed on Sep. 30, 2016 including the specification, drawings and abstract is incorporated herein by reference in its entirety.

### BACKGROUND

### 1. Technical Field

The present disclosure relates to a lithium ion secondary battery.

### 2. Description of Related Art

Since lithium ion secondary batteries are lighter in weight and higher in energy density than conventional batteries, they have recently been used as a so-called portable power supply for a computer and a mobile terminal and a power supply for driving a vehicle. Particularly, lithium ion secondary batteries are expected to be increasingly used in the future as a high output power supply for driving a vehicle such as an electric vehicle (EV), a hybrid vehicle (HV), and a plug-in hybrid vehicle (PHV).

As a technique for a lithium ion secondary battery, for example, the technique described in Japanese Patent Application Publication No. 2014-241198 (JP 2014-241198 A) may be exemplified. JP 2014-241198 A described that a lithium ion secondary battery using a specific electrolyte solution containing a specific lithium salt at a high concentration exhibits excellent rate characteristics.

### SUMMARY

In a lithium ion secondary battery, lithium ions act as charge carriers, and charging and discharging are performed when lithium ions move between a positive electrode and a negative electrode. The inventor studied the relationship between a lithium ion concentration in an electrolyte solution and the conductivity of lithium ions. The result showed that, when a lithium ion concentration in an electrolyte solution increases as in, for example, JP 2014-241198 A, the conductivity of lithium ions in the electrolyte solution increases, which results in a theory that, when a concentration of lithium ions in the electrolyte solution of a lithium ion secondary battery increases, the conduction phenomenon of lithium ions that sequentially hop between solvent molecules in the electrolyte solution (hereinafter referred to as “hopping conduction”) easily occurs.

Based on this theory, the inventor further studied and found that there are the following problems regarding hopping conduction of lithium ions. That is, hopping conduction of lithium ions is conduction in a direction in one dimension and positions into which lithium ions are inserted into an electrode material are concentrated. Thus, according to hopping conduction, there is a problem in that, since a rate at which lithium ions diffuse in a solid is low and an electrode material is generally a solid, the reaction resistance increases due to a delay in diffusion in a solid.

The present disclosure provides a lithium ion secondary battery having low reaction resistance.

An aspect of the present disclosure relates to a lithium ion secondary battery including a positive electrode, a negative electrode, and an electrolyte solution. At least one of the positive electrode and the negative electrode includes a magnetic field generating material. In such a configuration, when hopping conduction of lithium ions occurs, due to a magnetic field generated by the magnetic field generating material, a movement direction of lithium ions that conduct a current in a direction in one dimension can be changed according to the Lorentz force, and it is possible to improve the diffusibility of lithium ions in the planar direction. Therefore, diffusion of lithium ions in a solid is likely to occur, and it is possible to reduce the reaction resistance.

The positive electrode may include a positive electrode active material layer containing a positive electrode active material. The positive electrode active material layer may contain the magnetic field generating material. The magnetic field generating material may be a magnetic conversion material that generates a magnetic field when lithium ions are inserted into the positive electrode active material. In such a configuration, when lithium ions are inserted into the positive electrode active material, since the magnetic conversion material is changed to a ferromagnetic material, it is possible to generate a magnetic field from the magnetic conversion material very effectively. Thus, a movement direction of lithium ions can be easily changed due to the Lorentz force and the diffusibility of lithium ions in the planar direction can be easily improved. As a result, it is very easy to reduce the reaction resistance.

The magnetic field generating material may be a nanocoil that generates a magnetic field when a current flows in the lithium ion secondary battery. In such a configuration, when a current flows through the nanocoil, it is possible to generate a magnetic field from the nanocoil very effectively. Thus, a movement direction of lithium ions can be easily changed due to the Lorentz force and the diffusibility of lithium ions in the planar direction can be easily improved. As a result, it is very easy to reduce the reaction resistance.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a cross-sectional view schematically showing an internal structure of a lithium ion secondary battery according to an embodiment of the present disclosure;

FIG. 2 is a schematic diagram showing a configuration of a wound electrode body of the lithium ion secondary battery according to the embodiment of the present disclosure; and

FIG. 3 is a graph showing simulation results obtained when a magnetic conversion material is included in a positive electrode of a lithium ion secondary battery as a magnetic field generating material.

### DETAILED DESCRIPTION OF EMBODIMENTS

Embodiments of the present disclosure will be described below with reference to the drawings. Components other than those particularly mentioned in this specification that are necessary for implementation of the present disclosure (for example, a general configuration and manufacturing process of a lithium ion secondary battery that does not characterize the present disclosure) can be recognized by those skilled in the art as design matters based on the related art in the field. The present disclosure can be implemented based on content disclosed in this specification and common general technical knowledge in the field. In addition, in the following drawings, members and portions having the same functions are denoted by the same reference numerals. In addition, the sizes (a length, a width, a thickness, and the like) in the drawings do not reflect actual sizes

Here, “secondary battery” in this specification refers to a general power storage device capable of performing charging and discharging repeatedly, and is a term that includes a so-called storage battery and a power storage element such as an electric double-layer capacitor. In addition, “lithium ion secondary battery” in this specification refers to a secondary battery which uses lithium ions as charge carriers and can perform charging and discharging according to charge transfer with lithium ions between positive and negative electrodes.

As a flat and rectangular lithium ion secondary battery including a flat wound electrode body and a flat battery case, the present disclosure will be described below in detail. However, this is not intended to limit the present disclosure to that described in such embodiments.

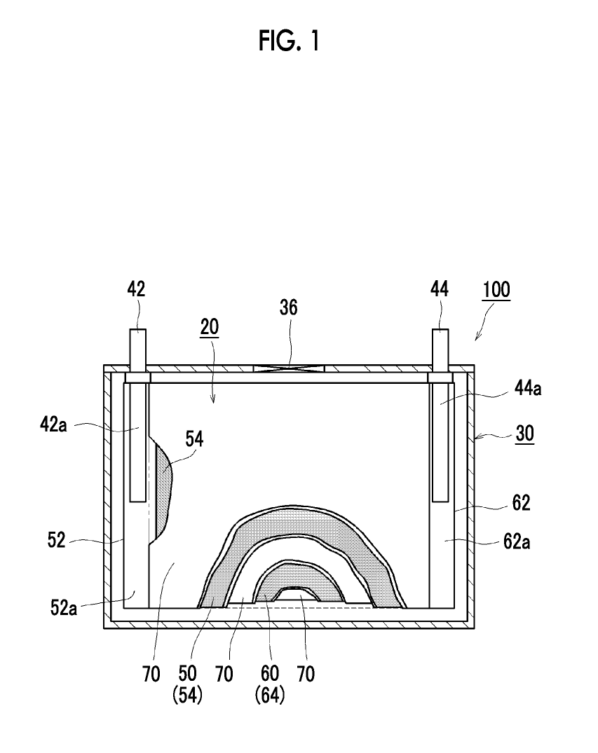

A lithium ion secondary battery 100 shown in FIG. 1 is a sealed lithium ion secondary battery 100 in which a flat wound electrode body 20 and a nonaqueous electrolyte solution (not shown) are accommodated in a flat and rectangular battery case (that is, an outer container) 30. A positive electrode terminal 42 and a negative electrode terminal 44 for external connection and a thin safety valve 36 configured to release an internal pressure when the internal pressure of the battery case 30 increases to a predetermined level or higher are provided in the battery case 30. In addition, an inlet (not shown) through which a nonaqueous electrolyte solution is injected is provided in the battery case 30. The positive electrode terminal 42 is electrically connected to a positive electrode current collecting plate 42a. The negative electrode terminal 44 is electrically connected to a negative electrode current collecting plate 44a. As a material of the battery case 30, a lightweight metal material having favorable thermal conductivity, for example, aluminum, is used.

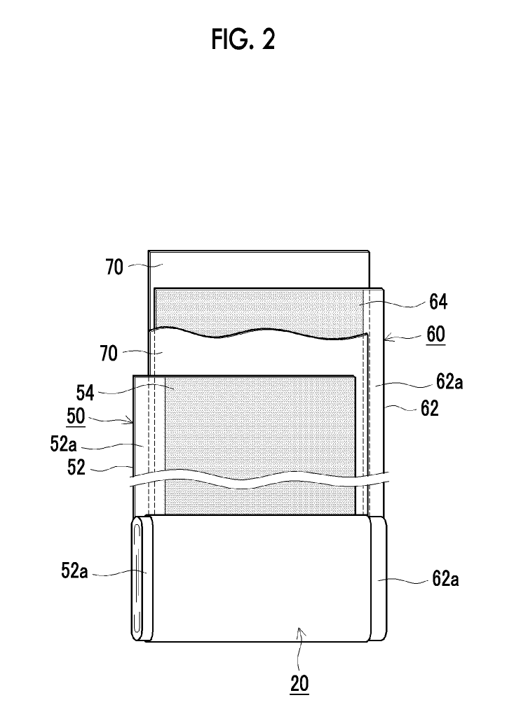

As shown in FIG. 1 and FIG. 2, the wound electrode body 20 has a form in which a positive electrode sheet (it is also referred to as a positive electrode) 50 in which a positive electrode active material layer 54 is formed on one surface or both surfaces (here, both surfaces) of an elongated positive electrode current collector 52 in a longitudinal direction and a negative electrode sheet (it is also referred to as a negative electrode) 60 in which a negative electrode active material layer 64 is formed on one surface or both surfaces (here, both surfaces) of an elongated negative electrode current collector 62 in the longitudinal direction are superimposed with two elongated separator sheets (it is also referred to as a separator) 70 therebetween and wound in the longitudinal direction. Here, the positive electrode current collecting plate 42a and the negative electrode current collecting plate 44a are bonded to a positive electrode active material layer non-forming portion 52a (that is, a portion in which no positive electrode active material layer 54 is formed and the positive electrode current collector 52 is exposed) that is formed to protrude outward from both ends in a winding axis direction (refers to a sheet width direction orthogonal to the longitudinal direction) of the wound electrode body 20 and a negative electrode active material layer non-forming portion 62a (that is, a portion in which no negative electrode active material layer 64 is formed and the negative electrode current collector 62 is exposed), respectively.

As the positive electrode current collector 52 of the positive electrode sheet 50, for example, an aluminum foil may be exemplified. As a positive electrode active material contained in the positive electrode active material layer 54, for example, a lithium transition metal oxide (for example, LiNi_{1/3}Co_{1/3}Mn_{1/3}O₂, LiNiO₂, LiCoO₂, LiFeO₂, LiMn₂O₄, LiNi_{0.5}Mn_{1.5}O₄) and a lithium transition metal phosphate compound (for example, LiFePO₄) may be exemplified. The positive electrode active material layer 54 may include, for example, a conductive material and a binder, as components other than the active material. As the conductive material, for example, carbon black such as acetylene black (AB) and other carbon materials (for example, graphite) are preferably used. As the binder, for example, polyvinylidene fluoride (PVDF) may be used.

As the negative electrode current collector 62 of the negative electrode sheet 60, for example, a copper foil may be exemplified. As a negative electrode active material contained in the negative electrode active material layer 64, carbon materials, for example, graphite, hard carbon, and soft carbon may be used. The negative electrode active material layer 64 may include, for example, a binder and a thickener, as components other than the active material. As the binder, for example, styrene butadiene rubber (SBR) may be used. As the thickener, for example, carboxymethyl cellulose (CMC) may be used.

Here, in the lithium ion secondary battery 100, at least one of the positive electrode 50 and the negative electrode 60 includes a magnetic field generating material. Typically, at least one of the positive electrode active material layer 54 and the negative electrode active material layer 64 includes a magnetic field generating material. Therefore, when hopping conduction of lithium ions occurs, due to a magnetic field generated by the magnetic field generating material, a movement direction of lithium ions that conduct a current in a direction in one dimension can be changed according to the Lorentz force, and it is possible to improve the diffusibility of lithium ions in the planar direction. Accordingly, diffusion of lithium ions in a solid is likely to occur. That is, since the positive electrode 50 and the negative electrode 60 are made of generally a solid material, the diffusibility of lithium ions in the electrode material is improved. Thus, it is possible to reduce the reaction resistance.

As an example, the positive electrode active material layer 54 includes a magnetic field generating material. The magnetic field generating material is a magnetic conversion material that generates a magnetic field when lithium ions are inserted into a positive electrode active material. In this case, when lithium ions are inserted into the positive electrode active material, since the magnetic conversion material is changed to a ferromagnetic material, it is possible to generate a magnetic field from the magnetic conversion material very effectively. Thus, a movement direction of lithium ions can be easily changed due to the Lorentz force and the diffusibility of lithium ions in the planar direction can be easily improved. As a result, it is very easy to reduce the reaction resistance. As an example of such a magnetic conversion material, a neutral layered compound in which a paramagnetic paddlewheel-type dinuclear ruthenium (II, II) metal complex is crosslinked with tetracyanoquinodimethane (TCNQ) derivatives may be exemplified. However, the present disclosure is not limited thereto, and a metal-organic substance skeleton in which a paramagnetic metal complex is crosslinked with a neutral organic substance may be used.

As another example, at least one of the positive electrode 50 (particularly, the positive electrode active material layer 54) and the negative electrode 60 (particularly, the negative electrode active material layer 64) may include a magnetic field generating material, and the magnetic field generating material may be a nanocoil that generates a magnetic field when a current flows in the lithium ion secondary battery 100. In this case, when a current flows through the nanocoil, it is possible to generate a magnetic field from the nanocoil very effectively. Thus, a movement direction of lithium ions can be easily changed due to the Lorentz force and the diffusibility of lithium ions in the planar direction can be easily improved. As a result, it is very easy to reduce the reaction resistance. As an example of such a nanocoil, a carbon nanocoil (CNC) having a helical structure may be exemplified. However, as long as a conductor has a helical structure, the type of conductor is not limited.

Here, the type of magnetic field generating material is not limited to the above examples if the material exhibits a desired effect. The content of the magnetic field generating material may be appropriately set according to the type of magnetic field generating material.

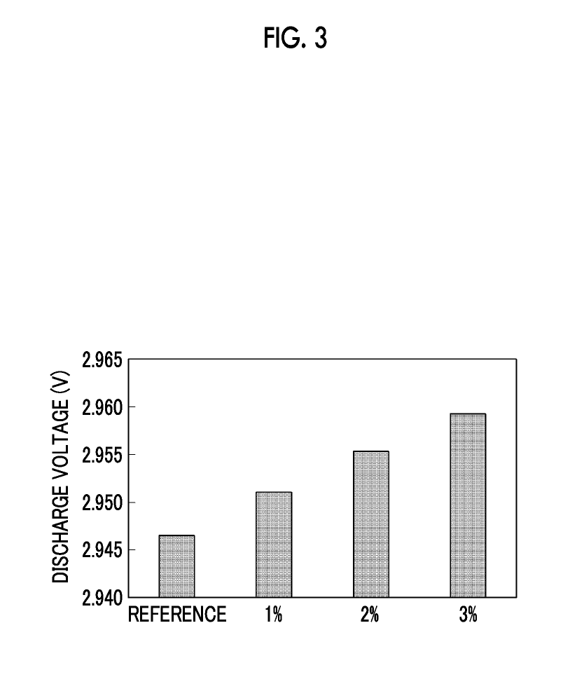

FIG. 3 shows simulation results obtained when a magnetic conversion material is included in a positive electrode of a lithium ion secondary battery as a magnetic field generating material. The simulation was performed on a large cell including an electrolyte solution containing LiPF₆ with a concentration of 2 M (2 mol/L) as a supporting salt and a positive electrode including a magnetic conversion material. In the simulation, a discharge voltage when discharging was performed at 30 C from a state of charge (SOC) of 60% at 10° C. was evaluated. The large cells that have been evaluated were large cells in which the content of a magnetic conversion material in a positive electrode was 1 volume %, 2 volume %, and 3 volume % and a reference large cell that included no magnetic field generating material. As shown in FIG. 3, the discharge voltage increased as the volume fraction of the magnetic conversion material in the positive electrode increased. The increase in the discharge voltage means that the output was improved when the reaction resistance was reduced. It can be understood that, when the volume fraction of the magnetic conversion material in the positive electrode increased, since the volume fraction of a positive electrode material such as a positive electrode active material decreased, the output or the capacity was reduced, but as an effect greater than this, an output increasing effect caused by the reaction resistance reduction effect due to the magnetic conversion material was higher. Here, in the large cell with the highest discharge voltage in which the content of the magnetic conversion material was 3 volume %, the output increased by 0.4%. According to these simulation results, it can be clearly understood by those skilled in the art that, when at least one of the positive electrode 50 and the negative electrode 60 included a magnetic field generating material, the reaction resistance was reduced.

As the separator 70, a porous sheet (film) made of, for example, polyethylene (PE), polypropylene (PP), polyester, cellulose, or polyamide resin, may be exemplified. The porous sheet may have a single layer structure or may have a structure in which two or more layers are laminated (for example, a three-layer structure in which a PP layer is laminated on both surfaces of a PE layer). A heat resistant layer (HRL) may be provided on the surface of the separator 70.

The same nonaqueous electrolyte solution as in a conventional lithium ion secondary battery can be used. Typically, a solution in which a supporting salt is included in an organic solvent (nonaqueous solvent) can be used. As the nonaqueous solvent, organic solvents such as various carbonates, ethers, esters, nitriles, sulfones, and lactones which are used in an electrolyte solution of a general lithium ion secondary battery can be used without particular limitation. As a specific example, ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), trifluorodimethyl carbonate (TFDMC), and the like may be exemplified. These nonaqueous solvents can be used alone or two or more thereof can be appropriately used in combination. As the supporting salt, a lithium salt is generally used. As an example of the lithium salt, LiPF₆, LiBF₄, LiClO₄ and the like may be exemplified. Among them, LiPF₆ is preferable. The concentration of the supporting salt in the nonaqueous electrolyte solution is not particularly limited. However, the concentration is preferably high since then hopping conduction of lithium ions easily occurs. As the concentration of the supporting salt in the nonaqueous electrolyte solution, 1.5 mol/L or more is preferable, 1.8 mol/L or more is more preferable, and 2.0 mol/L or more is most preferable. The concentration of the supporting salt in the nonaqueous electrolyte solution is preferably 5.0 mol/L or less, 4.0 mol/L or less is more preferable, and 3.0 mol/L or less is most preferable.

Here, the above nonaqueous electrolyte may include various additives, for example, a gas generating agent such as biphenyl (BP), and cyclohexylbenzene (CHB); a film forming agent such as an oxalato complex compound containing boron atoms and/or phosphorus atoms and vinylene carbonate (VC); a dispersant; and a thickener as long as the effect of the present disclosure is not significantly impaired.

The lithium ion secondary battery 100 having the configuration described above can be used for various applications. As a preferable application, a power supply for driving that is mounted on a vehicle such as an electric vehicle (EV), a hybrid vehicle (HV), and a plug-in hybrid vehicle (PHV) may be exemplified. Typically, the lithium ion secondary battery 100 can be used in the form of an assembled battery in which a plurality of batteries are connected in series and/or in parallel.

Here, as an example, the rectangular lithium ion secondary battery 100 including the flat wound electrode body 20 has been described. However, the lithium ion secondary battery can be configured as a lithium ion secondary battery including a laminated electrode body. In addition, the lithium ion secondary battery can be configured as a cylindrical lithium ion secondary battery.

While specific examples of the present disclosure have been described above in detail, these are only examples, and the present disclosure includes various modified and changed specific examples with respect to those exemplified in the above.

What is claimed is:

1. A lithium ion secondary battery comprising:
a positive electrode;
a negative electrode; and
an electrolyte solution,
wherein at least one of the positive electrode and the negative electrode includes a magnetic field generating material.

2. The lithium ion secondary battery according to claim 1, wherein
the positive electrode includes a positive electrode active material layer containing a positive electrode active material,
the positive electrode active material layer contains the magnetic field generating material, and
the magnetic field generating material is a magnetic conversion material that generates a magnetic field when lithium ions are inserted into the positive electrode active material.

3. The lithium ion secondary battery according to claim 1, wherein
the magnetic field generating material is a nanocoil that generates a magnetic field when a current flows in the lithium ion secondary battery.
